(19) United States
(12) Patent Application Publication
(10) Pub. No.: US 2004/0078307 A1
(43) Pub. Date: Apr. 22, 2004

(54) System and method for making financial updates and tracking tax status over a computer network

(76) Inventor: Sondra Carver, Woodside, CA (US)

Correspondence Address: Sondra Carver, 2995 Woodside Road, Woodside, CA, 94062, US

(21) Appl. No.: 10/250,804

(22) PCT Filed: Jan. 8, 2002
(86) PCT No.: PCT/US02/00980

(51) Int. Cl. G06F 17/60

(52) U.S. Cl. 705/31

(57) ABSTRACT

A system and business method for conveniently dealing with various financial and tax-related transactions and updating financial and tax status over a computer network such as the Internet is disclosed. One or more Internet web sites permit remote users to establish accounts and run user sessions that involve the tracking and storing of financial and tax-related data. This data is then used in conjunction with existing software programs to automatically generate financial and tax summaries and reports on demand and in real time at any remote location and at any time of the year. The inventive system and business method also permits for hypothetical adjustments or extrapolations of data for analytical purposes, and also provides for direct live contact with a tax or accounting professional where desired by the user.

### NOTICE OF PRIORITY

This application claims priority from U.S. Provisional Application No. 60/260,229 filed on Jan. 9, 2001, which is incorporated herein in its entirety by reference.

### FIELD OF THE INVENTION

The present invention relates generally to a system and method for conducting business over a computer network, and more specifically to a system and method for accessing and working with financial and tax documents over the Internet.

### BACKGROUND OF THE INVENTION

Most individuals and businesses presently utilize the services of a tax professional to complete their tax returns, and either enter the data for their accounting records in-house or pay someone to generate that data for them. Such individuals and businesses usually wait anxiously through a lengthy process for their tax professionals to complete their tax returns without knowing exactly what their tax is until their tax returns are fully completed at the time of their tax filing date. Without a real time understanding of their tax burden, however, individuals and businesses are hindered in altering or even effectively planning for their tax burden; because they do not know of its exact amount and are not aware of the financial decisions that could adjust their taxes due.

This problem has only been partially solved by tax programs that estimate taxes due after already compiled and logged accounting data is manually reentered into the tax programs themselves. Such tax programs are typically used only by tax and accounting professionals, however, as these programs are often difficult to use, are very expensive and require specialized knowledge to verify the correctness of the conclusions presented by the numbers. As a result, real time financial and tax-related data are generally not available on demand to the average individual or business.

The emergence of the Internet has provided a new way for individuals and businesses to communicate and has also provided a convenient way to access and store information. The vast majority of Americans and people in other industrialized nations now have Internet access, and as such an opportunity has thus evolved to enable people to track, store, access and analyze their financial and tax-related data. Accordingly, what is desired is a system that tracks and stores financial data, automatically generates and transfers this data to tax summaries and programs on demand, creates compilations of accounting and financial information, and recommends changes and planning techniques based on this data and other user input.

### SUMMARY OF THE INVENTION

The present invention provides a system and method for conveniently dealing with various financial and tax-related transactions and updating financial and tax status over a computer network such as the Internet. According to a preferred embodiment of the present invention, various types of financial or tax-related transactions may be conducted or tracked at several computer network locations or web addresses. In particular, a single Internet web site may be used to track, compile and analyze a wide variety of transactions for a particular user on demand and in real time. According to the present invention, the inventive web site utilizes the download capabilities of various software programs and Internet web sites and into these programs incorporates the already recorded data of any user to generate a variety of financial and tax-related documents for that user. Financially and tax relevant transactions are tracked and recorded into a secure database for instant use in various financial and tax preparation computer software programs, such that current statistics and projected results and advice are immediately available to the user from any remote location and at any time of the year.

The present invention gathers financial and tax-related data automatically from the web sites of various financial entities and stores this data in a standardized format that is organized by user in a secure database. This data is then used by either proprietary or commercially available financial and tax software programs that use generally accepted accounting principles in varying formats to present results in the form of generally accepted accounting presentations. Under the present invention, accounting data for each user is tagged such that the inventive program carries each item of data to the appropriate line of any financial statement, accounting ledger, tax summary or tax return that the user wishes to complete and view.

According to the present invention, several computer network locations or web addresses, or alternatively a particular Internet web site, such as taxproficient.com, provide a way for any user to review current financial summaries and project tax burdens under a variety of hypothetical situations. A user may thus review both its current financial status and tax burden, and may also extrapolate, project or otherwise predict the totals for various financial items and sources such that potential period end burdens can be estimated and even altered or changed. Under the present invention, the user may elect to manually input certain numbers and items or may allow the program to do so automatically. A reconciliation report formats the data to provide a check for the user to determine if all data transferred properly. Corrections or refinement of data maybe achieved by discussions with tax and accounting professionals of the inventive web site should the user express unique needs.

The interface between the inventive web site and user may involve only a simple format with basic options or may contain advanced versions including other services as described in more detail below. Various toolbars offer different choices to the user, including the ability to pick user and other fictional names, code informational choices and ask questions of a live tax or accounting professional through a secure electronic mail protocol. Pop-up windows are also available as the user passes a cursor over presented items and numbers, and these windows give the user additional information concerning the significance and positioning of the noted items or numbers. Double-clicking on items or numbers separates any aggregation and gives the user a separate detailed listing of the descriptions for those items or numbers.

Guaranteed security of all identifying data and characteristics is provided, and a user may utilize fictional euphemisms or other coded information as desired. Password protection is required of all users and accounts, and all data receives further encryption during transmission and data storage such that access is prohibited by anyone but the data owner. An identifying data legend or decoder is also possessed only by the user and owner of the information, and is held only in the remote computer of the user and/or the computer of a user designated accounting or tax professional.

### BRIEF DESCRIPTION OF THE DRAWINGS

The included drawings are for broad illustrative purposes and serve only to provide examples of possible structures for the disclosed inventive web site. These drawings in no way limit any changes in form and detail that may be made to the invention by one skilled in the art without departing from the spirit and scope of the invention.

FIG. 1 is a flow diagram overview of the process once a user has authorization to enter and use the taxproficient.com web site for producing the data of the user.

FIG. 2 is a flow diagram of the process of downloading and creating the data and processing information through the web site.

FIG. 3 is a flow diagram of the process to authorize a new web site user to full membership status.

### DETAILED DESCRIPTION

Modern technologies such as computer networks and the like, and especially the Internet, offer new opportunities for people to conduct, track and analyze various financial and tax-related transactions. The present invention provides a system and method for conveniently dealing with electronically stored data for such transactions and updating financial and tax status over a computer network such as the Internet. One object of the present invention is to facilitate the tracking, storage, and on-demand retrieval of financial data and tax-related transactions for convenient use in financial and tax preparation software programs at any time, and this object is achieved by the system and method disclosed herein. In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

The present invention provides a system and method for conveniently conducting, tracking, storing and analyzing various financial and tax-related transactions over a computer network such as the Internet. This system and method of conducting such transactions and business includes providing one or more computer servers capable of hosting one or more Internet web sites, such server or servers having standard features and capabilities as would be well known to one skilled in the art. Such server capabilities include, for example, the ability to register clients, to start client sessions, to send commands to start a client program, to receive commands from a remote computer, to pass commands to a software session, and to transmit data to a remote computer. According to the present invention, this system and method permits remote users to establish individual or business accounts, to store data securely to be retrieved and analyzed on demand, and to be charged for selected services via their established accounts through methods and techniques that are well known to those skilled in the art.

According to the present invention, the tracking and storing of data, as well as the various generated outputs, such as tax summaries and accounting ledgers and financial statements, are accomplished and produced on any readily available and capable standard computer hardware. A typical hardware configuration for hosting the inventive web site and performing the system and method described herein may consist of one or more 700 Megahertz or higher Pentium or other clone-like chip computers utilizing 100 to 400 megabyte hard drives with a 128K or greater random access memory. This hardware links to switching equipment allowing for uninterrupted transmission to other servers and at least one back-up domain server along with the corresponding transfer of data from the inventive web site and one or more companion mirror web sites. Additional equipment may also be used to provide faster downloads of data not only to users of the web site but also to the web site itself, regardless of any limitations or hardware or software configurations in the responding equipment. These specifications are only provided as an example, however, as other hardware configurations may also be acceptable as will be readily understood by one skilled in the art. Java, Visual Basic and/or one or more derivative languages such as C++ are the preferred computer languages for writing the software program for the inventive web site, although the actual computer language or languages used may differ as desired.

According to a preferred embodiment of the present invention, various sources of income, assets, expenditures, and other types of financial or tax-related transactions may be conducted and/or tracked at several computer network locations or web addresses. In particular, a single Internet web site or brand, such as that found at www.taxproficient.com for example, may be used to track, compile, store and subsequently analyze a wide variety of financial transactions for a particular user on demand and in real time. Live financial and tax professionals are also provided under the inventive system and method, and users may access these professionals for discussion or advice as needed, preferably via hotlines or through the web site itself. Prospective users may operate within a selected portion or portions of the inventive web site under an evaluation status but must eventually become members and subscribe to the web site to receive full or continuing service.

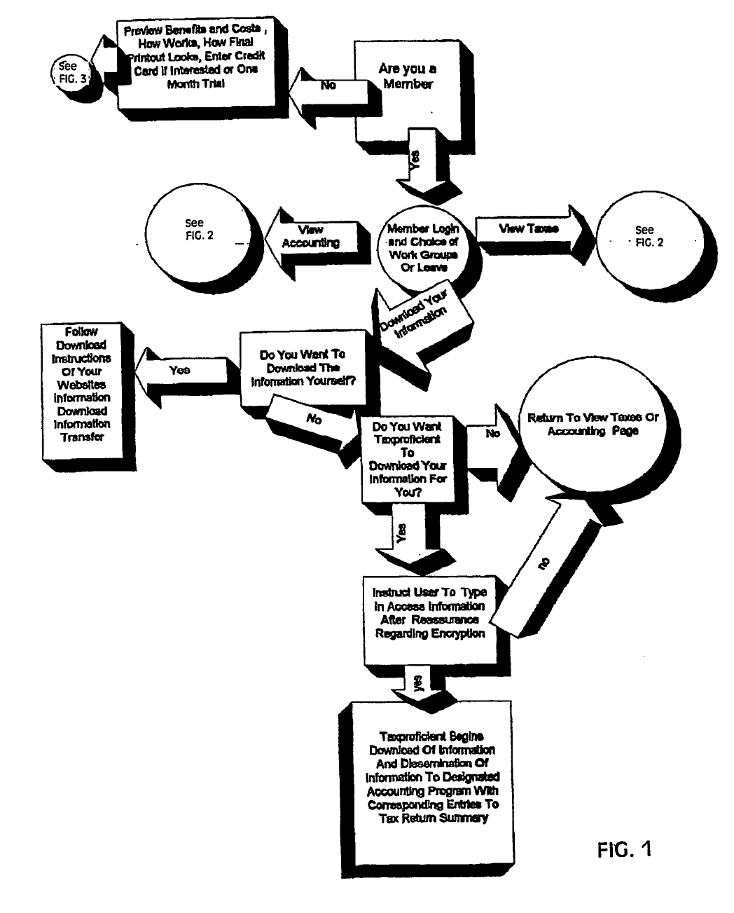

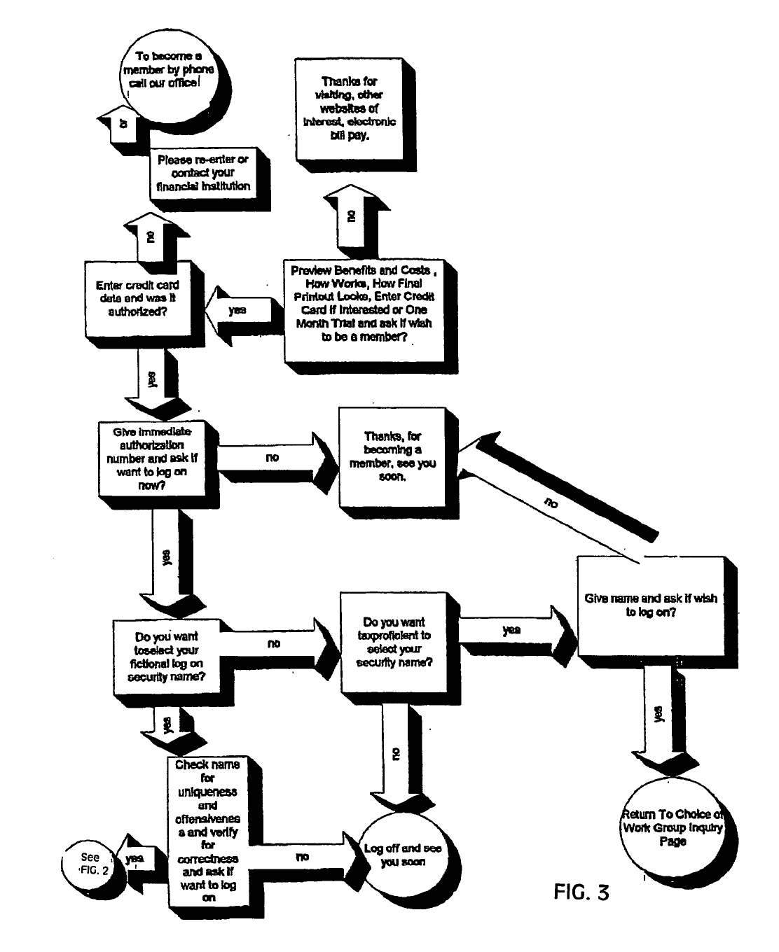

Turning now to FIG. 1, a flow diagram of an overview of the process once a user or prospective user has obtained authorization to enter and use the inventive web site is provided. At an initial step, the program determines whether the user is a member or not. This may be done, for example, through a graphical link for “Members” or “Member Sign-In” or through any other suitable member determination means as is known in the art. If that determination is negative and the user is not a member, then that user is preferably directed toward one or more informational pages that may include such things as previews on benefits and costs of the system, how the system works and examples of final charts, results, summaries and/or printouts. Such informational pages may also include an inquiry of or offer to the user for a trial membership to the web site. Such a membership may last, for example, one month, and may or may not be charged at a promotional or reduced rate, or may even be free in some instances. Preferably, the user will be required to submit a credit card number, and this number may be used for future billing, identification and/or authorization purposes. Should the user elect for a trial membership to the web site, this process is then continued at FIG. 3, which is set forth in more detail below.

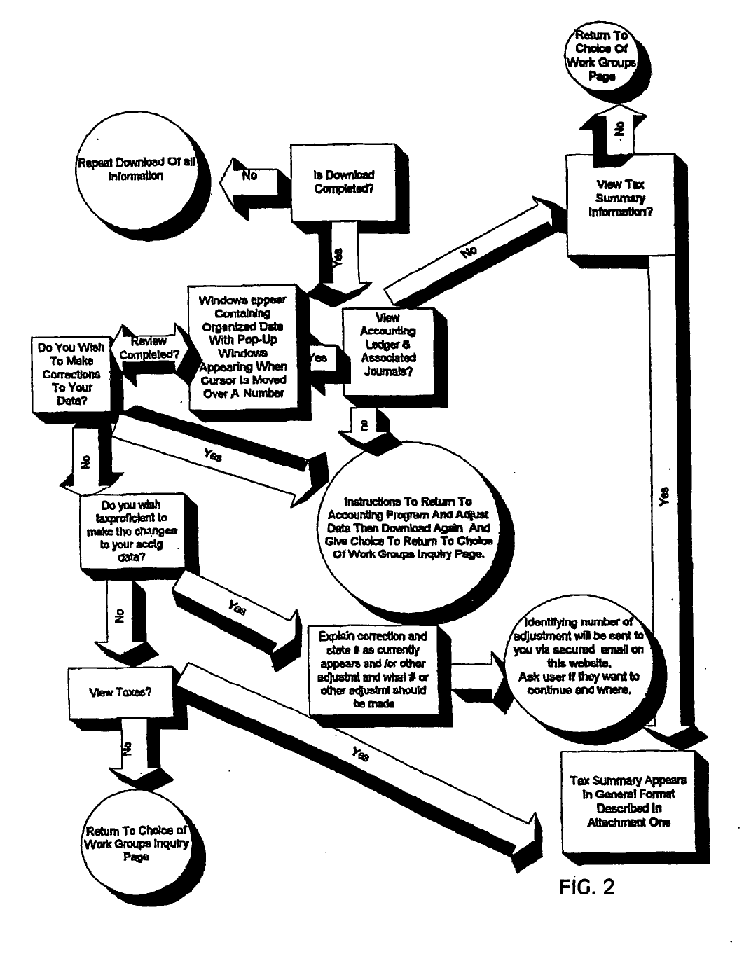

If, on the other hand, the user is determined to be a member, then the user is routed to a Member Login page or pop-up where the user must input its code name and password. Once the log in process is complete the user is given several choices, which include the ability to view summaries or results or to download additional information. Should the user elect to view summaries or results, such as accounting or tax summaries, the process is continued at FIG. 2. Should the user elect to download information, then the user is preferably asked whether the information is to be downloaded manually by the user. If the user elects to download information manually, then the user is directed to download or information transfer instructions particular to the web site or web sites from which the user will request information. The user may then proceed by following such instructions. If the user does not choose to download its own information manually; then preferably the user is asked for approval that the inventive web site download such information. If the user does not approve of such an automatic download; then the user is redirected to another page, such as the viewing of tax or accounting summaries or results, which is continued at FIG. 2. Should the user approve of an automatic download of information by the web site, however, then the user is provided with reassurance that the following transaction will be protected through standard encryption processes. Such a reassurance may be made via a pop-up window, through an additional web page, or through other appropriate means as is known in the art. The user is then prompted for access information and codes or passwords as necessary. Should this process fail or should the user decline to provide this information, then the user is redirected to another page, such as the viewing of tax or accounting summaries or results, which is continued at FIG. 2. Should the proper access codes and passwords be provided, then the automatic download process begins as authorized, and dissemination of information regarding the user is made from various sources to the inventive web site. Subsequent handling and use of this information is described in greater detail below.

Turning now to FIG. 2, a flow diagram of the process of downloading and creating the data and processing information through the web site is provided. As a first step, a confirmation is preferably made that any desired download of new or additional information has been properly completed. Should this prove to be false; then such a download must be repeated, or an error reported. If any new or additional download of information is in order, however, then a user is prompted for what type of information it wishes to view. Such an inquiry may be made in an order, for example, with accounting ledgers and associated journals being presented as the first option in the order. Should a user not desire to view such information; then the user would be presented with one or more other choices, such as tax summary information. If no choice is ultimately made, then the user would be redirected to another page, which could be, for example, a choice of work groups page to name a particular page. Conversely, if the user elects to view tax summary information; then the user would be given a tax summary, preferably in a general format as previously described to or designated by the user.

Should the user originally desire to view accounting information, however, then windows containing organized data would be provided. As detailed below, such windows would preferably include the use of pop-up windows that contain additional details or information when the cursor is moved. Once the user has finished reviewing the data, the user is preferably asked whether the user wants to make corrections to the data manually. Should corrections be desired, then instructions can be made regarding returning to the accounting program to adjust data before re-downloading the data. The user could also be redirected or given the option of being redirected to another page, which could be, for example, a choice of work groups page. Should the user not wish to make corrections to the data manually, then the user is preferably also given the option to have the web site program make corrections to the data automatically. If such an action is not desired, then the user can pass out of the view accounting mode and into another mode, such as viewing taxes or tax summaries. Should the user wish to have the web site program automatically correct the data, however, then such corrections are made. Preferably, each correction is explained to the user and identified in detail, noting the old number and the new corrected or suggested number. A confirmation of any change is then preferably sent to the user via a secured electronic mail for verification purposes. The user is then presented with other options as before, such as to pass out of the view accounting mode and into another mode, such as the view taxes or tax summaries mode.

Turning now to FIG. 3, a flow diagram of the process to authorize a new web site user to fill membership status is provided. In a first step, a user is preferably directed toward one or more informational pages that may include such things as previews on benefits and costs of the system, how the system works and examples of final charts, results, summaries and/or printouts. Such informational pages may also include an inquiry of or offer to the user for a trial membership to the web site as discussed previously. Should the user decline such an offer, then the user is preferably directed to an exit page thanking the user for visiting the web site and preferably providing the user with other web sites of interest, such as electronic bill pay sites for example. Should the user choose to subscribe to the web site or elect for a trial membership, then credit card information for the user must be entered. Any appropriate process for entering, accepting and authorizing the credit card information of a user as is known in the art is sufficient, with examples including separate web pages, secure pop-up windows, or the like. Should authorization of a user's card not be made; then a user is preferably re-prompted for the information. If this process should fail, then a user is given the option of becoming a member by phone and a telephone number is provided at that point for the user to join.

If the provided credit card is authorized, however, then the user is preferably asked if the user wishes to log in at that point. If not, the user is thanked for joining the web site and becoming a member and is welcomed to come back at a later time. The next step, whether immediately after signing up or at a later log in, is for the user to select a fictional log in and security name. The user is preferably asked if he or she wishes to select his or her own security name. If so, the user submits a name, and this name is checked for uniqueness, offensiveness and to see if it is the correct name that the user has chosen. If one or more of the foregoing is not acceptable, then the name selection process is repeated until an acceptable name is assigned. Once such a name is assigned, then the user is prompted to see if he or she wishes to log in to the system at that time. If so, then the user is sent into the process continued at FIG. 2. If not, then the user is logged off and is welcomed to return at a later time. Should the user not desire to select their own security name, however, then the user is asked if the inventive web site may do that for the user. If the user declines to select its own security name or have this done by the web site automatically; then the user is preferably logged off and welcomed to return at a later time. Should the user allow the web site to select the user security name; then this selection is made automatically. The user is then given his or her new security name and provided with the option of logging off or continuing onward, which process is continued at FIG. 2.

Once a user account is established and proper authorization is given, the inventive web site gathers financial and tax-related data automatically from the web sites of banks, credit card providers, electronic bill pay providers and any other place where such data is stored or input. Upon retrieval of data in this manner, the inventive program coordinates the data, removes and assigns new identifiers to sensitive data, reintegrates the data into one or more accounting programs designated by the user, and then transfers the accounting data to one or more tax programs designated by the user. User data may also be converted from the many source formats into one standardized site format and stored in a secure database on the inventive web site for future use in additional software programs not yet available or designated by the user. Such a database is organized and stores data by user such that all data for a particular user is readily accessible for use in any downloaded or proprietary financial software program upon later designation or demand.

According to a preferred embodiment of the present invention, taxproficient.com utilizes the download and functional capabilities of various independent software programs and Internet web sites that are already in existence. The present invention may be compatible with and thereby utilize various commercial accounting and tax software including, but not limited to, Prosystemfx, Lacerte, Quickbooks Pro, Financial Navigator, AccPac, Peachtree, American Contractor, Ask Manman and Timberline. Alternatively, the inventive system and method may be adapted to utilize additional programs not listed or not yet in existence. Such programs may be proprietary or otherwise native to the inventive web site, or may be those that are commercially available, and in any event use generally accepted accounting principles in varying formats, which include ledgers, journals, income statements, balance sheets, ratio data, statements of cash flow and the like, as well as any other generally accepted accounting presentation. In practice, many or all commercially available and downloadable financial software programs will be present on the inventive web site for utilization by any user or subscriber, such that it would not become necessary to repeatedly download an entire program for each individual user. Repeated utilization of one or more commercially available programs may raise copyright and use issues, however, such that each user may be required to pay additional licensing fees per independent program used as necessary. The operators of the inventive web site would track program usage and license purchases, and then forward such fees to the appropriate software owner in such instances.

The data of any particular user that is recorded and stored in a secure database is automatically input into one or more of these downloaded programs on demand to generate a variety of financial and tax-related documents for that user. Such documents may include state and federal tax summaries, accounting ledgers and all associated financial statements, and even payroll and sales tax summaries and the like. All kinds and types of tax returns may also be formulated, including income tax returns, estate tax returns, gift tax returns, fiduciary tax returns, sales and use tax returns, payroll tax returns, non-profit tax returns, corporate tax returns, partnership tax returns and any other kind of tax return that may be required now or in the future. The user may be any taxpayer of a given country whether they reside in that country or abroad, as the one or more financial or tax software programs used can themselves separately account for differences in tax laws and residence status. In addition to the standard reports and summaries issued in the format of the various commercially available software programs, the inventive program may also issue a supplemental summary sufficient to explain such professional reports to a layperson user. In this manner, an average user may better understand their particular tax and/or accounting status and position. Further discussion and advice may be sought from the online tax and accounting professionals at the inventive web site, if necessary.

Under the present invention, a key feature is that manual re-entry of data into a particular program and its specific format is not necessary. Instead, accounting data for each user is tagged, recorded and stored, such that the data may be automatically used in one or more various software programs at a later time. Such a function is first performed through use of input daemons or parsers and bridges, as is well known to those skilled in the art. For example, an input parser can be set to watch a user directory on the inventive host web site. As one or more files enter the directory, the input parser notes file identifying information and selects an appropriate input “bridge” for each incoming data file. Such bridges comprising executable files that function to translate files into different formats are well known modular software objects, and as such may be easily composed by those skilled in the art once the required file formats are known. Each incoming file is processed with the appropriate executable file, or bridge, into a Common Data Format (“CDF”) that is standard for the database associated with the host web site. The core of the host system is essentially the definition of the CDF, and a CDF is generally a superset of the most common data sources. An incoming data file, which is validated once it is in CDF form, is then stored on the database for future use.

A standard software agent may then be used to identify various items, such as deductibles, using several methods either by default or as preferred by the user. In this way, a wide variety of items, such as medical expenses or vehicle expenses for example, may be tagged for future use and calculation. Since assumptions must be made in such a tagging process, these are typically presented to the user for verification or acceptance. A user or operator may then elect to enter a user data set or files into a particular software program for analysis. Once a command is given, output bridges then translate the CDF data for a given user into an appropriate format for the program or presentation that requires the data. Examples would include HTML for presentations on a web page, text for electronic mail messages, Excel formats, or specialized formats for one of the many commercialized tax or financial programs, such as Lacerte. Such output bridges are modular software objects similar to the input bridges in the foregoing, and likewise may be easily understood and composed by those skilled in the art once the required file formats are known.

In this manner, incoming data is converted into CDF format and stored as such, and can then be transferred as an entire data set to one or more desired programs for computation and analysis. The present invention thus permits any business or individual to track and record any and all financially and tax-relevant transactions into a secure database for instant use in various financial and tax preparation computer software programs, such that current statistics and projected results and advice are immediately available to the user from any remote location and at any time of the year. In addition to providing users with completed accounting summaries and tax returns, the various data outputs for a user are assigned designators, which designators generate informational notes and planning suggestions for the user concerning the number or numbers in a particular location and designation. Such concrete results, notes and advice are standard under typical tax preparation and practice.

According to a preferred embodiment of the present invention, of which taxproficient.com comprises a part, several computer network locations or web addresses, or alternatively a particular Internet web site such as taxproficient.com, also provide a way for any user to review current financial summaries and project tax burdens under a variety of hypothetical situations. Businesses and individuals are thus given an opportunity not only to aggregate electronically data existing in various locations outside the web site to review and analyze current financial status and tax burdens, but also to extrapolate, project or otherwise predict totals for various yet unrealized financial items and sources, such that potential period end burdens can be estimated under different proposed scenarios. Under the present invention, the user may elect to manually input certain line and item numbers and items or may request that the inventive program do so automatically using user data stored in the database and/or other user specified parameters. In this manner, a user may not only view and anticipate its current tax status and burden, but may also learn how this status and burden can change if the user takes certain actions, conducts various financial transactions, makes any status changes or receives alternative or additional sources of income. The user can then make comparisons between the different financial and tax implications of various future choices and paths, and this is all accomplished with or without the manual input of any data, as desired by the user.

A user may not only wish to view its current yearly or quarterly to date financial status and tax burden, but may also want to extrapolate that status or burden or add new factors that have not yet been computed into the present results. For example, an individual may be anticipating a change in marital status, the arrival of one or more new children or dependents, taking on new stock options, beginning a new business, or engaging in numerous new investments, any of which would have substantial tax implications. Salary increases or bonuses may also be anticipated and input into the system to augment any simple extrapolation of data and results. A business may desire to analyze the tax implications of a particular major purchase or path of expansion, and may even compare the ramifications of alternative purchases or paths. Under the present invention, any perceived change or addition may be accounted for and input into the system for analysis.

According to the present invention, a reconciliation report is provided to format the data and to provide a check for the user to determine if all existing data transferred properly into the downloaded software program or programs. This report is generated via software native to the inventive web site, which may be designed or written via techniques and algorithms well know to those skilled in the art. Such a reconciliation report can also ensure that added or extrapolated data is correct and includes data summaries as well as detailed information on each tracked and recorded item. The level of detail on each item may be selected by the user to confirm accuracy. This reconciliation report also allows a user to place a request to the web site staff to correct erroneous data coding if necessary. Further refinement of data may be achieved by direct discussions with one or more tax or accounting professionals of the inventive web site, wherein the user expresses unique needs such as dissolution or entry of new partners, among many possible issues. A tax or accounting professional may then customize a program or certain numeric entries as needed for a particular user for greater accuracy or estimation purposes according to the needs or requests of the user. Such discussions may be initiated through one or more of the various toolbars or links provided in the interface between the user and the inventive web site, as discussed in more detail below.

The interface between the inventive web site and user may involve only a simple format with basic options or may contain advanced versions. Various toolbars offer different choices to the user and help to streamline the integration and download of electronic data from a myriad of Internet sites containing electronically stored financial data belonging to the user. Toolbar choices may include one or more of the following: downloading tax summaries and various types of financial statement and accounting reports, formatting such reports in a wide variety of ways, requesting certain types of reports and or graphics, requesting certain periods of time and/or budgeting projections from input data, picking user and other fictional names or coding of information choices, and electronically mailing questions to a tax or accounting professional. Such questions are preferably processed via a secure electronic mail protocol to a professional staff member at the inventive web site. The exact design and appearance of each toolbar is not critical to the present invention, and as such may vary as desired. Toolbar functionality, design and appearance may be set by the programmer, or alternatively, additional advanced features may permit a user to customize the functionality, design and appearance of one or more toolbars, the provision of such ability as would be readily understood by one skilled in the art.

In addition to toolbars, user friendly pop-up windows are also available under the present invention. As the user passes a cursor over certain presented items and/or numbers, pop-up windows give the user additional details or information concerning the computation, significance and/or positioning of the noted items or numbers. For purposes of illustration, a particular line item on a tax return may call for a number of dependents, for which the inventive program has entered a “2” according to the data set of a particular user. Should that user pass an on-screen cursor over the “2” entry, a small floating window, preferably of a differing color, font size and/or format, would then pop-up with further information or details regarding that entry. Such information may only delineate, for example, “Sally Jones, Ted Jones,” or may add more details such as age and relationship status. In addition, such pop-up windows may contain suggestions or details concerning qualifications for certain credits or status. As another example, a dollar figure entry on a particular line may represent a summation of a plurality of separate stored financial items. Should a user pass a cursor over such an entry, a pop-up window would then list the various individual dollar totals that resulted in that entry. Additional details such as when and where each individual stored item originated may also be provided as desired. Accordingly, these pop-up windows may have detail levels and options that can be toggled by the user under a settings toolbar. Such pop-up windows and settings are provided through standard programming techniques that are well known to those skilled in the art.

In addition to pop-up windows, a “double-clicking” feature is included under the present invention to provide a user with a means for reviewing details. A user may choose to pass a cursor onto certain items or number entries and then double click a mouse button or otherwise command the program to provide additional information or details on the item or entry of interest. This information may be provided, for example, in a separate large window that may be maximized on the computer screen for detailed review. Alternatively, this information may be printed or otherwise presented to the user in an acceptable reviewing format. This double-clicking feature thus expands upon what can be presented in a limited pop-up window in that it may provide for a substantial level of detail or length of listed items. Lengthy aggregations of numbers and/or detailed descriptions may thus be separated, listed and presented to the user in a reviewable format.

Guaranteed security of all identifying data and characteristics is provided, and a user may select from varying levels of security and specialized coding as desired. Particularly identifying information such as names, account numbers, social security numbers, addresses or other revealing information may be specially tagged or coded by the user, and such information either completely absent from the data or exists as substituted information such as fictional euphemisms or other coded information. Password protection is required of all users and accounts through methods readily known to those skilled in the art. In addition, all data receives standard or additional encryption during transmission and data storage, such that access is prohibited by anyone but the data owner and/or an accounting or tax professional as designated by the data owner. An identifying data legend or decoder is also possessed only by the user and owner of the information and/or a user designated accounting or tax professional and is held only in the remote computer of such a person or persons.

Although the foregoing invention has been described in some detail by way of illustration and example for purposes of clarity and understanding, it will be recognized that the above described invention may be embodied in other specific forms without departing from the spirit or essential characteristics of the invention. Certain changes and modifications may be practiced, and it is understood that the invention is not to be limited by the foregoing details, but rather is to be defined by the scope of the appended claims.

What is claimed is:

1. A method of tracking and analyzing financial or tax-related transactions over the Internet, comprising:
(a) providing at least one computer server for hosting one or more Internet web sites;
(b) permitting a remote user to establish an account, whereby said remote user may utilize the services provided by said at least one computer server;
(c) accepting electronically transmitted data from one or more outside locations, said electronically transmitted data comprising financial or tax-related information pertaining to said remote user; and
(d) automatically inputting said electronically transmitted data into one or more software programs in order to provide said user with an output from said one or more software programs.

2. The method of claim 1, wherein said one or more software programs comprise one or more commercially available accounting or tax software programs.

3. The method of claim 2, wherein said user is not required to manually re-enter said electronically transmitted data into any of said one or more commercially available accounting or tax software programs.

4. The method of claim 1, wherein said output includes one or more summaries or reports generated by the computer software native to said one or more Internet web sites.

5. The method of claim 4, wherein said output includes a reconciliation report.

6. The method of claim 1, further comprising the step of:
(e) providing a customized set of user interface mechanisms, whereby said set of user interface mechanisms permit a user to select from and utilize one or more commercially available accounting or tax software programs.

7. The method of claim 1, further comprising the step of:
(e) providing direct assistance from one or more live tax or accounting professionals via said one or more Internet web sites.

8. The method of claim 1, further comprising the step of:
(e) removing and assigning one or more new identifiers to one or more selected items from said electronically transmitted data.

9. The method of claim 1, further comprising the step of:
(e) charging said remote user a membership fee via said established account.

10. A system of tracking and analyzing financial or tax-related transactions over the Internet, comprising:
(a) at least one computer server for hosting one or more Internet web sites, said at least one computer server capable of starting a client session, sending a command to start a client program, receiving commands from a remote computer, passing commands to a software session, gathering data from a remote source, storing said data, and transmitting said data to a remote computer;
(b) one or more user accounts, whereby a remote user may utilize one or more services provided by said at least one computer server;
(c) one or more financial or tax-related computer software programs; and
(d) one or more bridges for automatically transferring electronically transmitted data into said one or more computer software programs.

11. The system of claim 10, wherein said one or more financial or tax-related computer software programs comprise one or more commercially available accounting or tax software programs.

12. The system of claim 11, wherein said remote user is not required to manually reenter said electronically transmitted data into any of said one or more commercially available accounting or tax software programs.

13. The system of claim 10, wherein said remote user is charged a membership fee via said user account.

14. A method for updating and determining accounting and tax information in real time on a computer network, comprising:
(a) gathering data for a user from various sources electronically;
(b) compiling and storing said data electronically;
(c) viewing said data from various sources;
(d) manipulating said data under one or more available financial or tax software programs;
(e) aggregating said data into a multitude of usable formats;
(f) utilizing pop-up windows, said pop-up windows containing informational notes and recommendations;
(g) generating special accounting reconciliation and tax reconciliation reports used to verify the complete transfer of all data; and

15. The method of claim 14, further comprising the step of:
(h) correcting said data by a live tax or accounting professional.

16. The method of claim 14, further comprising the step of:
(h) analyzing said data by a live tax or accounting professional.
